(19) United States
(12) Patent Application Publication
(10) Pub. No.: US 2009/0314154 A1
(43) Pub. Date: Dec. 24, 2009

(54) GAME DATA GENERATION BASED ON USER PROVIDED SONG

(75) Inventors: Christopher Esaki, Redmond, WA (US); Keiichi Yano, Tokyo (JP)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/142,832

(22) Filed: Jun. 20, 2008

(51) Int. Cl. G10H 1/40

(52) U.S. Cl. 84/611

(57) ABSTRACT

The vocal track of any song provided by a user may be isolated and data based on the vocal track, such as pitch, rhythm, and/or duration, may be generated. The data may be used in a game in which the user may sing into a microphone and may try to match their singing as closely as possible to that of the vocal track. Feedback may be provided to the user at as to how the user's singing compares with respect to the vocal track based on the on the pitch, rhythm, and/or duration.

### BACKGROUND

A song is a musical composition which contains vocal parts that are sung with the human voice and generally feature words, referred to as lyrics, commonly accompanied by other musical instruments. A vocal track comprises the lyrics. Karaoke is a form of entertainment in which amateur singers sing along with recorded music using a microphone and public address system. The music is typically a song in which the voice of the original singer is removed or reduced in volume. Lyrics may be displayed on a video screen, along with a moving symbol or changing color, to guide the singer.

Games have been developed for computing devices that include aspects of karaoke. The games include a game disk that contains pre-recorded songs. A user chooses one of the pre-recorded songs from the game disk and may sing along to the song with on-screen guidance. The lyrics to the song scroll on the screen, above a representation of the relative pitches at which they are to be sung. The game provides feedback to the user on how well the user is matching the pitch of the song. The game analyzes a user's pitch and compares it to the original song, with users scoring points based on how accurate their singing is.

### SUMMARY

The vocal track of any song provided by a user may be isolated and data based on the vocal track, such as pitch, rhythm, and/or duration, may be generated. The data may be used in a game in which the user may sing into a microphone and may try to match their singing as closely as possible to that of the vocal track. Feedback may be provided to the user at as to how the user's singing compares with respect to the vocal track based on the pitch, rhythm, and/or duration.

In an implementation, the song may be provided from a portable media player to a multimedia console. The multimedia console may isolate the vocal track and provide the game environment to the user.

In an implementation, the song may be commercially available (e.g., for purchase, download, etc.) or may have been generated by the user or another entity, regardless of whether amateur or professional.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method for generating game data based on a user provided song;

FIG. 3 is an operational flow of an implementation of a method for using game data based on a user provided song; and

FIG. 4 illustrates functional components of an example multimedia console computing environment.

### DETAILED DESCRIPTION

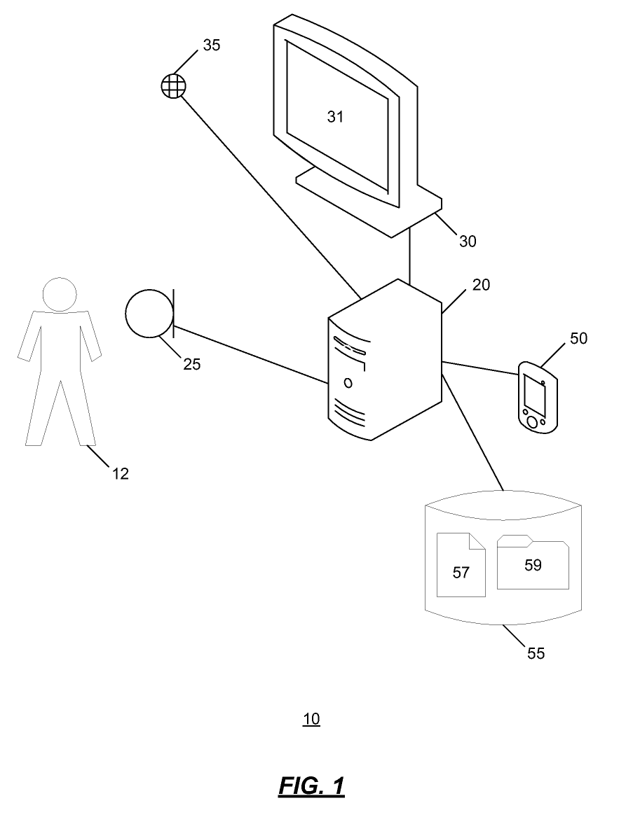

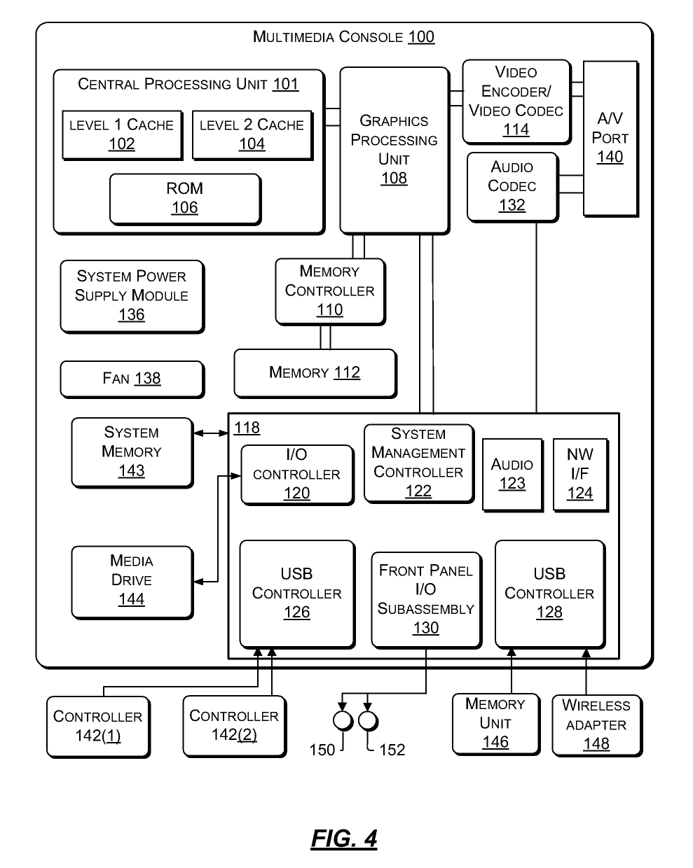

FIG. 1 shows an example of a computing environment 10 in which aspects and embodiments may be potentially exploited. The environment 10 includes a computing device 20. The computing device 20 may comprise a personal computer (PC), a gaming console, or multimedia console, for example. Although a multimedia console may be described with respect to the aspects and embodiments herein, it is contemplated that any computing device may be used. An example multimedia console is described with respect to FIG. 4.

The computing device 20 may have an associated display device 30 which may be a computer display or monitor, for example. The display device 30 may be used to provide graphical output 31 to a user 12. The graphical output 31 may comprise a listing of songs, lyrics of a selected song, feedback about the user's 12 singing of a song (i.e., the user's singing of the lyrics of a song), and other information pertaining to the user, the song(s), and/or the user's performance of one or more songs.

The computing device 20 may have an associated microphone 25 into which the user 12 may sing the lyrics of the song. The computing device 20 may also have an associated speaker 35, such as a loudspeaker, a computer speaker, or a multimedia speaker. The speaker 35 may output sound, such as the song and/or the lyrics that are sung by the user 12.

A portable media player 50 may store a music library of songs, e.g., stored by the user 12 pursuant to the user's purchase, download, generation and/or other acquisition of the songs. The portable media player 50 may be put into communication with the computing device 20 (e.g., via a wired or wireless connection) and may provide a song to the computing device 20 for analysis and playing in a game environment, as described further herein.

Other storage devices, such as a storage device 55, may store at least one song 57 and/or a folder 59 of songs. The storage device 55 may be any type of computer data storage and may be internal to or external from the computing device 20. The user 12 may store one or more songs on any number of storage devices, although only one storage device 55 is shown.

The songs that may be stored on the portable media player 50 and/or the storage device 55 may be stored as audio data files using known techniques. Any audio file format(s) may be used. An audio file format is a container format for storing audio data on a computer system. A technique for storing digital audio is to sample the audio voltage which, on playback, would correspond to a certain position of the membrane in a speaker of the individual channels with a certain resolution (e.g., the number of bits per sample) in regular intervals (e.g., the sample rate). This data can be stored uncompressed or compressed to reduce the file size. There are three major groups of audio file formats: uncompressed audio formats, formats with lossless compression, and formats with lossy compression.

The user 12 may select a song from storage on the portable media player 50 or on the storage device 55 and provide the song to the computing device 20. In an implementation, the computing device 20 may retrieve or otherwise receive the audio data file associated with the selected song from the portable media player 50 or the storage device 55 using known data retrieval and/or receiving techniques. The computing device 20 may store the song on storage associated with the computing device 20 and may analyze the song. An analysis of the song may comprise isolating the vocal track and determining information pertaining to the sung lyrics of the song, such as the pitch, rhythm, and duration of the lyrics of the song as sung by the original singer (i.e., the singer of the vocal track that has been isolated).

The vocal track may be isolated using any known phase cancellation technique along with frequency limiting. Any signal that is reproduced on both the left and right channels (or the center channel) may be subject to frequency analysis and may then be isolated if within a range of frequencies (e.g., the lows and highs of the human voice). The isolated vocal track may then be analyzed to generate game data, such as pitch, rhythm, and duration information. Pitch is an auditory attribute of sounds and represents the perceived fundamental frequency of a sound. Rhythm is the variation of the length and accentuation of a series of sounds. Duration is an amount of time or a particular time interval of one or more aspects of music.

In another implementation, spectral analysis may be used to isolate the vocal track. Spectral analysis is a technique that decomposes a time series into a spectrum of cycles of different lengths. Spectral analysis is also known as frequency domain analysis.

The information thus generated from a user provided song file containing a vocal track may be stored as game data for subsequent use in a game that may be run on the computing device 20. As described further herein, the user 12 may sing into the microphone 25 along with music. The user 12 interfaces with the computing device 20 while music and perhaps a video plays on the computing device 20 and may be outputted through the speaker 35 and/or the display device 30. Features of the user's 12 vocals may be compared with corresponding features of the vocals of the original track. Feedback may be provided to the user 12 and the user 12 may score points based on how accurate their singing is.

The microphone 25 captures the singing by the user 12 and may provide the sound as signals (e.g., voice data) to the computing device 20. The computing device 20 may determine information about the received sound (i.e., the voice data), such as the pitch, rhythm, and/or duration. The determined information may be compared to the information that had been previously determined and stored for the song as sung by the original singer. The comparison may be used to evaluate the similarity of the user's singing to the original singing. Feedback based on the comparison may be provided to the user 12 via the display device 30.

The computing device 20 may determine the pitch, rhythm, and/or duration using digital signal processing, which analyzes the frequencies of the incoming signals corresponding to the sounds sung by the user 12 into the microphone 25. The frequencies may be compared to stored information to evaluate the similarity to the original vocal track.

Alternatively, the microphone 25 may determine the pitch, rhythm, and/or duration using digital signal processing, and may provide this information to the computing device 20 for use in a comparison with that of the original vocal track.

Thus, an interactive singing experience may be created from an audio data file. Although audio data files are described, it is contemplated that any type of media data file may be used such as a multimedia data file and a video data file, along with their appropriate file format(s).

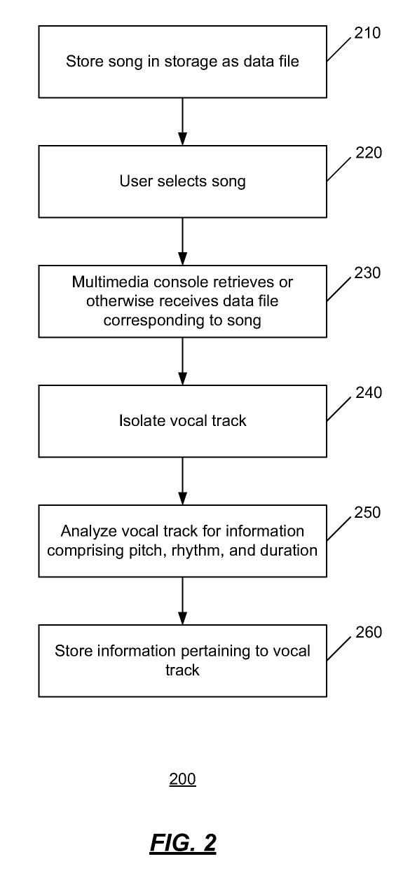

FIG. 2 is an operational flow of an implementation of a method 200 for generating game data based on a user provided song. At 210, a song may be stored in storage as a data file, such as an audio data file or other media data file. The song may be stored on any type of storage (e.g., the portable media player 50, the storage device 55, etc.) and may be in any file format. The song may be stored by a user or other entity, and may be commercially available (e.g., for purchase, download, etc.) or may have been generated by the user or another entity, regardless of whether amateur or professional. It is contemplated that any song, regardless of its source or artist, may be stored and used as described herein.

At 220, the user may select the song e.g., via an interface on a multimedia console (such as the computing device 20) or another computing device. The data file corresponding to the song may thus be provided to the multimedia console from storage such as the portable media player 50 or the storage device 55. In an implementation, the storage may be provided by the user and may be external to or separate from the multimedia console.

At 230, the multimedia console may retrieve or otherwise receive the data file from the storage. The multimedia console may store the data file locally. At 240, the vocal track of the song may be isolated from the data file. In an implementation, phase cancellation or spectral analysis may be performed on the data in the data file and the voice data corresponding to the vocal track may be extrapolated or otherwise extracted.

At 250, the vocal track may be analyzed to determine information about the vocal track, such as pitch, rhythm, and duration. At 260, the information may be stored in storage associated with the multimedia console and may be used in a game.

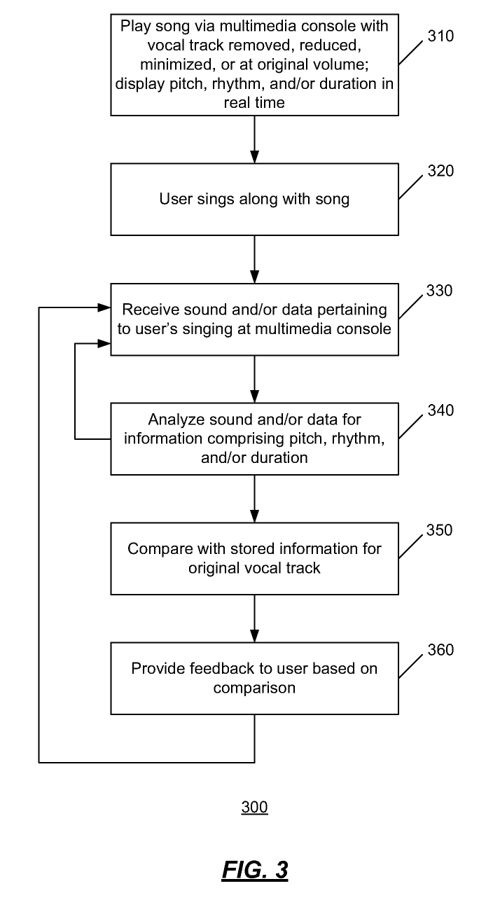

FIG. 3 is an operational flow of an implementation of a method 300 for using game data based on a user provided song. At some point, at 310, a song, such as the song described with respect to the method 200 of FIG. 2, may be played by the multimedia console with the vocal track removed, reduced, minimized, or played at original volume. In an implementation, information pertaining to the song, such as the pitch, rhythm, and/or duration of the vocal track may be displayed in real time to the user (e.g., on the display device 30) as the song is played.

The user may sing in real time into a microphone, at 320, following along with the information (e.g., the pitch, rhythm and/or duration), and may try to match their singing as closely as possible to that of the vocal track. At 330, the multimedia console may receive the sound and/or data pertaining to the user's singing from the microphone.

At 340, the sound and/or data may be analyzed to determine information such as pitch, rhythm, and/or duration. The information may be compared to the corresponding stored information pertaining to the original vocal track at 350. Feedback may be provided to the user at 360 based on the comparison. The feedback may comprise comments and/or a score as to how the user's singing compares with respect to the original vocal track.

In an implementation, the analysis at 340 may be performed as the user sings and may be stored for comparison at a later time, e.g., after the song is finished, after the user stops singing, etc. In such a case, 330 and 340 may loop until the until the song is finished, and then the comparison at 350 may be performed. Alternatively, the multimedia console may receive all of the sound and/or data pertaining to the user's singing of the song at 330 before analysis may be performed at 340. In such implementations, feedback to the user may not be provided in real time as the user is singing.

In another implementation, feedback may be provided to the user at 360 in real time as the user is singing. Thus, processing may continue by looping to 330 as feedback is provided at 360. Processing may continue until the song ends.

FIG. 4 illustrates functional components of an example multimedia console 100 computing environment. The multimedia console 100 has a central processing unit (CPU) 101 having a level 1 cache 102, a level 2 cache 104, and a flash ROM (read only memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (random access memory).

The multimedia console 100 includes an I/O controller 120, a system management controller 122, an audio processing unit 123, a network interface controller 124, a first USB host controller 126, a second USB controller 128, and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface controller 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications, and drivers. The CPU reservation is preferably maintained at a constant level.

With regard to the GPU reservation, lightweight messages generated by the system applications (e.g., popups) are displayed by using a GPU interrupt to schedule code to render popups into an overlay. The amount of memory required for an overlay depends on the overlay area size and the overlay preferably scales with screen resolution. Where a full user interface is used by the concurrent system application, it is preferable to use a resolution independent of game resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus multimedia application threads. The system applications are preferably scheduled to run on the CPU 101 at predetermined times and intervals in order to provide a consistent system resource view to the application. The scheduling is to minimize cache disruption for the multimedia application running on the console.

When a concurrent system application requires audio, audio processing is scheduled asynchronously to the multimedia application due to time sensitivity. A multimedia console application manager controls the multimedia application audio level (e.g., mute, attenuate) when system applications are active.

Input devices (e.g., controllers 142(1) and 142(2)) are shared by multimedia applications and system applications. The input devices are not reserved resources, but are to be switched between system applications and the multimedia application such that each will have a focus of the device. The application manager preferably controls the switching of input stream, without knowledge the multimedia application's knowledge and a driver maintains state information regarding focus switches.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of generating game data, comprising:
receiving a song from a storage device, the song comprising a vocal track;
determining pitch, rhythm, and duration information of the vocal track; and
storing the pitch, rhythm, and duration information for use in a computer game.

2. The method of claim 1, further comprising:
receiving a selection of the song from a user prior to receiving the song from the storage device.

3. The method of claim 1, wherein the storage device is a portable media player.

4. The method of claim 1, wherein receiving the song comprises retrieving the song from the storage device.

5. The method of claim 1, wherein receiving the song comprises receiving a data file corresponding to the song.

6. The method of claim 1, wherein receiving the song comprises receiving the song from a user.

7. The method of claim 1, wherein the song is a user provided song.

8. The method of claim 1, further comprising:
isolating the vocal track using phase cancellation or spectral analysis prior to determining the pitch, rhythm, and duration information of the vocal track.

9. A game method, comprising:
receiving data pertaining to a user singing a song;
analyzing the data to determine pitch, rhythm, and duration information;
comparing the pitch, rhythm, and duration information to previously stored pitch, rhythm, and duration information for the song; and
providing feedback to the user responsive to the comparing.

10. The method of claim 9, wherein the previously stored pitch, rhythm, and duration information for the song comprises pitch, rhythm, and duration information for an original vocal track of the song.

11. The method of claim 9, further comprising:
playing the song with a vocal track of the song removed, reduced, minimized, or at original volume while receiving the data pertaining to the user singing the song.

12. The method of claim 11, further comprising:
displaying the previously stored pitch, rhythm, and duration information for the song via a display device while receiving the data pertaining to the user singing the song.

13. The method of claim 9, wherein the song is a user provided song.

14. The method of claim 9, wherein the feedback comprises a comment or a score.

15. A computer-readable medium comprising computer-readable instructions for gaming, said computer-readable instructions comprising instructions that:
determine first information pertaining to an original vocal track of a user provided song;
receive data pertaining to a user singing the song;
analyze the data to determine second information;
compare the second information to the first information to generate a comparison result; and
generate feedback responsive to the comparison result.

16. The computer-readable medium of claim 15, further comprising instructions that:
receive the user provided song from a user provided storage device.

17. The computer-readable medium of claim 16, wherein the user provided storage device comprises a portable media player.

18. The computer-readable medium of claim 16, wherein the instructions that receive the user provided song comprise instructions that retrieve a data file corresponding to the song from the user provided storage device.

19. The computer-readable medium of claim 15, wherein the first information comprises pitch, rhythm, and duration information of the original vocal track, and the second information comprises pitch, rhythm, and duration information of the user singing the song.

20. The computer-readable medium of claim 15, further comprising instructions that:
play the song with the original vocal track of the song removed, reduced, minimized, or at original volume while receiving the data pertaining to the user singing the song;
display the first information while receiving the data pertaining to the user singing the song; and
display the feedback on a display device.
